(19) United States
(12) Patent Application Publication
(10) Pub. No.: US 2025/0206007 A1
(43) Pub. Date: Jun. 26, 2025

(54) DECORATIVE SHEET

(71) Applicant: C.I.TAKIRON CORPORATION, Osaka-shi, Osaka (JP)

(72) Inventors: Hitomi ONO, Osaka-shi, Osaka (JP); Yosuke MIGUCHI, Osaka-shi, Osaka (JP); Anna YONEZAWA, Osaka-shi, Osaka (JP)

(21) Appl. No.: 18/848,468

(22) PCT Filed: Oct. 7, 2022
(86) PCT No.: PCT/JP2022/037601

§ 371 Date: Sep. 18, 2024

(30) Foreign Application Priority Data
Mar. 28, 2022 (JP) 2022-051597

(51) Int. Cl. B32B 27/30; B32B 27/04

(52) U.S. Cl. CPC B32B 27/30; B32B 27/04; B32B 2250/03; B32B 2307/408; B32B 2307/538; B32B 2451/00

(57) ABSTRACT

A decorative sheet includes: a base material; and a surface layer located on the base material. The surface layer is composed of an ultraviolet-cured layer located on a surface of the base material and an excimer-cured layer located on a surface of the ultraviolet-cured layer. The surface layer contains a urethane acrylate and silicone, and a mass ratio of the urethane acrylate to the silicone in the surface layer is urethane acrylate:silicone=100:0.1 to 100:2.

### CROSS REFERENCE TO RELATED APPLICATIONS

This application is a national stage application, filed under 35 U.S.C. § 371, of International Application No. PCT/JP2022/037601, filed Oct. 7, 2022, which international application claims further priority to and the benefit of Japanese Application No. 2022-051597, filed Mar. 28, 2022; the contents of both of which as are hereby incorporated by reference in their entireties.

### BACKGROUND

### Technical Field

The present disclosure relates to a decorative sheet.

### Description of Related Art

Decorative sheets are used in various applications such as surface decorations of wall materials, moldings, building materials such as doors and windows, and furniture, automobile interiors, and low-voltage mountings to improve design by applying surface decorations. For example, decorative sheets in which a layer having a low gloss (matting) effect is provided on a base material are known in the art.

For example, a decorative sheet has been proposed that includes on a base material a decorative layer containing a colorant and also includes on the decorative layer a clear layer containing wet gel method silica particles having an average particle size of 5 μm or less as measured by the Coulter counter method (AP 50 μm). It is described that, with this configuration, a decorative sheet can be provided that has a satisfactory matte surface and suitably retains the color of a colored layer even through the decorative sheet has a clear layer containing inorganic particles (see, for example, Japanese Unexamined Patent Publication No. 2015-77691).

Another decorative sheet has also been proposed in which the surface of a coating film structure formed on a base material is irradiated with excimer light emitted from an excimer lamp to reduce the gloss of the portion of the surface of the coating film structure irradiated with electromagnetic waves compared to before the irradiation with the electromagnetic waves. It is described that, with this configuration, a decorative sheet having regions with different matte feelings can be provided (see, for example, Japanese Unexamined Patent Publication No. 2018-164901).

### BRIEF SUMMARY

However, in the decorative sheet described in Japanese Unexamined Patent Publication No. 2015-77691, silica particles are merely added to the clear layer, which does not provide a sufficient matting effect. This decorative sheet is therefore disadvantageous in that it is less likely to exhibit low glossiness.

In the decorative sheet described in Japanese Unexamined Patent Publication No. 2018-164901, no silica particles etc. are added to the clear layer, and the clear layer is merely irradiated with excimer light, which does not provide a sufficient matting effect. Moreover, asperities are unevenly formed in the clear layer. Therefore, this decorative sheet is disadvantageous in that it has a less aesthetic appearance (design).

The present invention was made to solve the above problems, and it is an object of the present invention to provide a decorative sheet that has low glossiness due to a matting effect and has an excellent aesthetic appearance.

In order to achieve the above object, a decorative sheet of the present invention is characterized by including: a base material; and a surface layer located on the base material. The surface layer is composed of an ultraviolet-cured layer located on a surface of the base material and an excimer-cured layer located on a surface of the ultraviolet-cured layer. The surface layer contains a urethane acrylate and silicone. A mass ratio of the urethane acrylate to the silicone in the surface layer is urethane acrylate:silicone=100:0.1 to 100:2.

According to the present invention, it is possible to provide a decorative sheet having low glossiness and having an excellent aesthetic appearance with uniform asperities formed in the entire surface of a surface layer.

### BRIEF DESCRIPTION OF THE FIGURES

FIG. 1 is a sectional view of a decorative sheet according to an embodiment of the present invention.

FIG. 2 is a laser micrograph showing the state of the surface of a surface layer in a decorative sheet of Example 1.

FIG. 3 is a laser micrograph showing the state of the surface of a surface layer in a decorative sheet of Comparative Example 3.

### DETAILED DESCRIPTION OF VARIOUS EMBODIMENTS

Hereinafter, a decorative sheet of the present invention will be specifically described. The present invention is not limited to the following embodiment and may be modified and applied as appropriate without departing from the spirit and scope of the present invention.

### <Decorative Sheet>

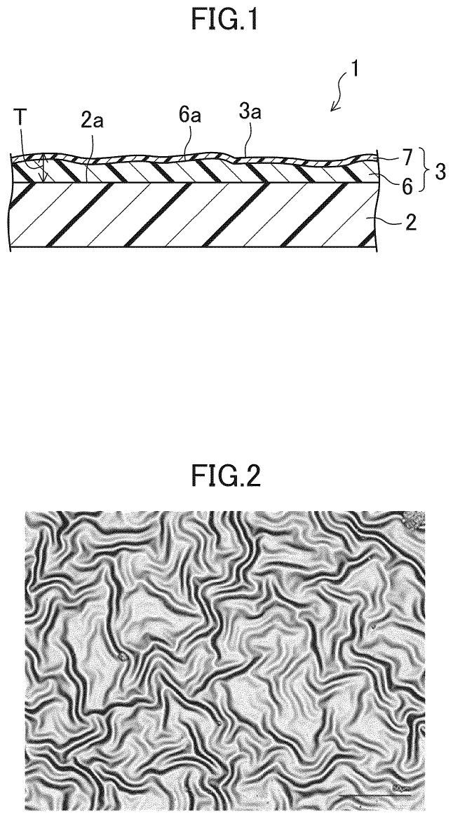

As shown in FIG. 1, a decorative sheet 1 of the present invention includes a base material 2 and a surface layer 3 formed on a surface 2a of the base material 2.

### <Base Material>

The base material 2 is, for example, a thermoplastic resin sheet. This thermoplastic resin sheet can be a sheet that is commonly used as a base material of the decorative sheet 2. Specific examples include a polyvinyl chloride sheet, a polyethylene terephthalate glycol-modified (PETG) sheet, an amorphous-polyethylene terephthalate (APET) sheet, a polyolefin sheet (polyethylene sheet, polypropylene sheet, etc.), an acrylonitrile butadiene styrene (ABS) sheet, and a polycarbonate sheet. The amorphous-polyethylene terephthalate (APET) sheet that is used as the base material 2 can be a recycled polyethylene terephthalate (RPET) sheet made of PET bottles etc.

The thermoplastic resin sheet is preferably a polyethylene terephthalate glycol-modified sheet from the standpoint of its ease of secondary curved surface processing and its excellent three-dimensional formability. A polyethylene terephthalate glycol-modified sheet is a type of polyethylene terephthalate. While polyethylene terephthalate contains ethylene glycol as a glycol component, polyethylene terephthalate glycol-modified is an amorphous polyester containing both ethylene glycol and a diol other than ethylene glycol (1,4-cyclohexanedimethanol) as glycol components.

The thermoplastic resin sheet may be either a stretched sheet or an unstretched sheet. The thermoplastic resin sheet may contain additives such as a colorant, an ultraviolet absorber, a light stabilizer, an antioxidant, an antistatic agent, a storage stabilizer, a lubricant, and a filler, as needed. The thermoplastic resin sheet is preferably colored from a design point of view.

The thickness of the base material 2 is, but not particularly limited to, preferably 50 μm to 800 μm, more preferably 250 μm to 500 μm. The base material 2 with a thickness of 50 μm or more sufficiently improves mechanical strength and concealability. The base material 2 with a thickness of 800 μm or less has better three-dimensional formability and easily provides sufficient flexibility and printability.

### <Surface Layer>

The surface layer 3 is a coating film of a paint mainly composed of a urethane acrylate and a mono-functional acrylate and containing silicone.

The surface layer 3 can be formed by coating the surface 2a of the base material 2 with a paint containing silicone and curing the paint. The surface layer 3 is composed of an ultraviolet-cured layer 6 formed on the surface 2a of the base material 2 and an excimer-cured layer 7 formed on a surface 6a of the ultraviolet-cured layer 6.

As shown in FIG. 1, a surface 3a of the surface layer 3 (i.e., the opposite surface from the base material 2) has wrinkles.

The urethane acrylate of the surface layer 3 is a di- to deca-functional urethane acrylate, such as a phenyl glycidyl ether acrylate hexamethylene diisocyanate urethane prepolymer, a pentaerythritol triacrylate hexamethylene diisocyanate urethane prepolymer, and a dipentaerythritol pentaacrylate hexamethylene diisocyanate urethane prepolymer. The urethane acrylate of the surface layer 3 may be a commercially available product such as EBECRYL 8402, KRM 8452, EBECRYL 210, EBECRYL 220, EBECRYL 4500, EBECRYL 230, EBECRYL 270, EBECRYL 4858, EBECRYL 8804, EBECRYL 8807, EBECRYL 9270, EBECRYL 4100, EBECRYL 4513, EBECRYL 8311, EBECRYL 8465, EBECRYL 9260, EBECRYL 8701, KRM 8667, EBECRYL 4265, EBECRYL 4587, EBECRYL 4200, EBECRYL 8210, EBECRYL 1290, EBECRYL 5129, EBECRYL 8254, EBECRYL 8301R, KRM 8200, KRM 8904, RUA-062-NS (product containing a di-functional acrylate monomer), U-6LPA, UA-1100H, U-200PA, UA-160TM, and UV-7600B (all of which are product names). These urethane acrylates may be used either alone or as a combination of two or more.

Examples of the mono-functional acrylate of the surface layer 3 include ethyl carbitol acrylate, methoxyethylene glycol (meth)acrylate, methoxypolyethylene glycol (meth)acrylate, β-(meth)acryloyloxyethyl hydrogen phthalate, β-(meth)acryloyloxyethyl hydrogen succinate, nonylphenoxyethyl (meth)acrylate, 3-chloro-2-hydroxypropyl (meth)acrylate, phenoxyethyl (meth)acrylate, phenoxy polyethylene glycol (meth)acrylate, butoxy polyethylene glycol (meth)acrylate, alkyl (meth)acrylate, cyclohexyl (meth)acrylate, tetrahydrofurfuryl (meth)acrylate, isobornyl (meth)acrylate, benzyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl-2-hydroxyethylphthalic acid, 3-acryloyloxyglycerine mono(meth)acrylate, 2-hydroxybutyl (meth)acrylate, 2-hydroxy-1-(meth)acryloxy-3-(meth)acryloxypropane, polypropylene glycol mono(meth)acrylate, polyethylene glycol mono(meth)acrylate, poly-caprolactone mono(meth)acrylate, dialkylaminoethyl (meth)acrylate, glycidyl (meth)acrylate, mono [2-(meth)acryloyloxyethyl] acid phosphate, trifluoroethyl (meth)acrylate, 2,2,3,3-tetrafluoropropyl (meth)acrylate, 2,2,3,4,4,4-hexafluorobutyl (meth)acrylate, perfluorooctylethyl (meth)acrylate, dicyclopentenyloxyalkyl (meth)acrylate, dicyclopentenyl (meth)acrylate, tricyclodecanyl (meth)acrylate, tricyclodecanyloxyethyl (meth)acrylate, and isobornyloxyethyl (meth)acrylate. These mono-functional acrylates may be used either alone or as a combination of two or more.

Although the blending ratio of the urethane acrylate to the mono-functional acrylate in the surface layer 3 is not particularly limited unless the characteristics of the decorative sheet 1 of the present invention are affected, the mass ratio of the urethane acrylate to the mono-functional acrylate is preferably in the range of 10:90 to 90:10. This is for the following reason. The urethane acrylate has low fluidity. Therefore, as the mass ratio of the urethane acrylate increases, wrinkles are less likely to be formed in the surface 3a of the surface layer 3, and the decorative sheet is less likely to exhibit low glossiness from the matting effect. The mono-functional acrylate has low reactivity. Therefore, as the mass ratio of the mono-functional acrylate increases, the paint is less likely to cure.

The thickness T of the surface layer 3 is, but not particularly limited to, preferably 1 μm to 45 μm, more preferably 1 μm to 10 μm. When the thickness of the surface layer 3 is less than 1 μm, the coating film region where silicone is movable during excimer irradiation, which will be described below, is reduced. Therefore, wrinkles are less likely to be formed, and the decorative sheet may be less likely to exhibit low glossiness from the matting effect. When the thickness of the surface layer 3 is greater than 45 μm, tactility further decreases and hardness increases, which may reduce formability. When the thickness of the surface layer 3 is greater than 10 μm, the surface roughness Sa of the surface layer 3 increases, which increases fingerprint resistance but may reduce tactility.

The decorative sheet 1 of the present invention is characterized in that the mass ratio of the urethane acrylate to the silicone in the surface layer 3 is urethane acrylate:silicone=100:0.1 to 100:2.

With this configuration, asperities are formed in the surface layer 3 by silicone with low surface tension. It is therefore possible to form uniform asperities in the entire surface 3a of the surface layer 3.

The mass ratio of the urethane acrylate to the silicone in the surface layer 3 is preferably urethane acrylate:silicone=100:0.3 to 100:1.5.

When the surface layer 3 contains less than 0.1 parts by mass of silicone per 100 parts by mass of urethane acrylate, the amount of silicone is so small that formation of wrinkles by silicone, which will be described later, is not sufficiently facilitated, which may make it difficult to form uniform asperities in the entire surface 3a of the surface layer 3. When the surface layer 3 contains more than 2 parts by mass of silicone per 100 parts by mass of urethane acrylate, the amount of silicone is so large that coating film defects occur due to the excess amount of silicone on the surface, and formation of wrinkles by silicone, which will be described later, is not sufficiently facilitated, which may make it difficult to form uniform asperities in the entire surface 3a of the surface layer 3.

Examples of the silicone include: acryloyl group-containing silicones such as an acryloyl group-containing modified polydimethylsiloxane, an acryloyl group-containing polyether modified polydimethylsiloxane, and an acryloyl group-containing polyester modified polydimethylsiloxane; and hydroxyl group-containing silicones such as a hydroxyl group-containing silicone modified acrylic.

Examples of commercially available acryloyl group-containing modified polydimethylsiloxanes include BYK-UV 3505 (two acryloyl groups) made by BYK-Chemie Japan. Examples of commercially available acryloyl group-containing polyether modified polydimethylsiloxanes include BYK-UV 3500 (two acryloyl groups) made by BYK-Chemie Japan. Examples of commercially available acryloyl group-containing polyester modified polydimethylsiloxanes include BYK-UV 3570 (two acryloyl groups) made by BYK-Chemie Japan. Examples of commercially available hydroxyl group-containing silicone modified acrylics include BYK-SILCLEAN 3700 made by BYK-Chemie Japan. These materials may be used alone or as a combination of two or more.

The paint for forming the surface layer 3 may also contain components other than the urethane acrylate, the mono-functional acrylate, and the silicone to the extent that the advantageous effects of the invention are not impaired. Examples of such other components include a photoinitiator, a weatherproofing agent, a colorant, an ultraviolet absorber, a light stabilizer, an antioxidant, an antistatic agent, a storage stabilizer, a plasticizer, a lubricant, and a filler.

Examples of the photoinitiator include an alkylphenone initiator, an acylphosphine oxide initiator, and a cationic initiator. Examples of the weatherproofing agent include an ultraviolet absorber and a light stabilizer.

### <Manufacturing Method>

When manufacturing the decorative sheet 1 of the present invention, the base material 2 that is, for example, the thermoplastic resin sheet described above is first prepared. The thermoplastic resin sheet may be either a commercially available thermoplastic resin sheet or a thermoplastic resin sheet manufactured by a known manufacturing method such as calendering or extrusion molding.

Next, the surface 2a of the base material 2 is coated with a paint containing a urethane acrylate, a mono-functional acrylate, a photoinitiator, and silicone to form a coating film, which will later become the surface layer 3, on the surface 2a of the base material 2.

For example, when a urethane acrylate containing a di-functional acrylate monomer such as RUA-062-NS mentioned above is used, the mono-functional acrylate may be omitted.

Examples of the coating method for the paint includes, but are not particularly limited to, cast coating, die coating, gravure coating, roll-knife coating, reverse roll coating, roll coating, and comma coating.

The coating film formed on the surface 2a of the base material 2 is then irradiated with excimer light. More specifically, the coating film is irradiated with excimer light having a short peak wavelength (in the range of 120 nm to 230 nm). Only the outermost surface of the coating film that will later become the surface layer 3 is thus cured to form the excimer-cured layer 7 described above.

At this time, non-uniformity occurs between the surface and inside of the coating film, so that the coating film component moves from the unreacted portion inside the coating film to the surface of the coating film. Wrinkles are thus formed in the surface of the coating film. This allows the surface layer 3 to have a low gloss (low glossiness). Since the silicone inside the coating film has low surface tension and tends to move to the surface of the coating film (i.e., the excimer-cured layer 7), the silicone facilitates the formation of wrinkles, so that asperities are formed in the surface. It is thus possible to form uniform asperities in the entire surface 3a of the surface layer 3.

When irradiating with excimer light using an excimer lamp, the peak wavelength of electromagnetic waves can be changed by changing a discharge gas used in the excimer lamp. Examples of the discharge gas for radiating excimer light having the above peak wavelength include Ar², Kr², and Xe².

The coating film is then irradiated with ultraviolet rays (350 mm to 450 nm) to form the ultraviolet-cured layer 6. The surface layer 3 composed of the ultraviolet-cured layer 6 formed on the surface 2a of the base material 2 and the excimer-cured layer 7 formed on the surface 6a of the ultraviolet-cured layer 6 is thus formed, and uniform asperities are formed in the entire surface 2a of the surface layer 3. The decorative sheet 1 thus manufactured still maintains low glossiness obtained by the excimer irradiation and has an improved aesthetic appearance due to the uniform asperities.

The coating film will not be completely cured by irradiating the coating film again with excimer light having a short peak wavelength (in the range of 120 mm to 230 nm) instead of the ultraviolet rays (350 mm to 450 nm).

In the decorative sheet 1 of the present invention, as described above, uniform asperities are formed in the entire surface 3a of the surface layer 3 by the silicone. Therefore, the standard deviation σ of the surface roughness Sa [μm] of the surface 3a of the surface layer 3 is 0.2 μm or less. The decorative sheet 1 having an excellent aesthetic appearance can be provided.

The “surface roughness Sa” as used herein refers to a “three-dimensional surface texture parameter (three-dimensional arithmetic average roughness)” as defined in ISO 25178.

The “standard deviation σ of the surface roughness Sa” indicates the spread width of the surface roughness Sa (variation in surface roughness Sa). This standard deviation σ can be obtained by the method that will be described later.

The decorative sheet 1 of the present invention has low glossiness because the gloss G of the surface 3a of the surface layer 3 is 5 or less due to the matting effect of the wrinkles described above.

The “gloss” as used herein is an index of low gloss properties, and refers to the 60° gloss as measured by the method according to JIS Z 8741:1997.

The gloss G is preferably 4 or less, more preferably 3 or less, from the standpoint of further improving low gloss properties and improving design.

As described above, in the decorative sheet 1 of the present invention, the surface layer 3 contains silicone and an urethane acrylate, and the mass ratio of the urethane acrylate to the silicone in the surface layer 3 is urethane acrylate:silicone=100:0.1 to 100:2. It is therefore possible to provide the decorative sheet 1 having an excellent aesthetic appearance with uniform asperities formed in the entire surface 3a of the surface layer 3.

It is also possible to provide the decorative sheet 1 having low glossiness due to the matting effect of the wrinkles described above.

### EXAMPLES

The present invention will now be described based on examples. It should be noted that the invention is not limited to these examples, these examples may be modified or changed without departing from the spirit and scope of the present invention, and such modifications and changes will not be excluded from the scope of the present invention.

The following materials were used to produce decorative sheets.
(1) Urethane acrylate 1: nona-functional urethane acrylate (made by Mitsubishi Chemical Corporation, product name: UV-7620EA)
(2) Urethane acrylate 2: deca-functional urethane acrylate (made by Mitsubishi Chemical Corporation, product name: UV-1700B)
(3) Urethane acrylate 3: hexa-functional urethane acrylate and hexa-functional acrylate (made by SHOWA INK MANUFACTURING CO., LTD, product name: HGUV-022)
(4) Mono-functional acrylate: tetrahydrofurfuryl acrylate (made by Kyoeisha Chemical Co., Ltd., product name: Light Acrylate THF-A)
(5) Silicone 1: acryloyl group-containing modified polydimethylsiloxane (made by BYK-Chemie Japan, product name: BYK-UV 3505)
(6) Silicone 2: hydroxyl group-containing silicone modified polyacrylate (made by BYK-Chemie Japan, product name: BYK-SILCLEAN 3700)
(7) Silicone 3: acryloyl group-containing polyester modified polydimethylsiloxane (made by BYK-Chemie Japan, product name: BYK-UV 3570)
(8) Initiator: alkylphenone photoinitiator (made by IGM Resins B.V., product name: Omnirad 1173)
(9) Initiator: alkylphenone photoinitiator (made by IGM Resins B.V., product name: Irgacure 184)

### Example 1

### <Production of Decorative Sheet>

First, a polyvinyl chloride sheet with a thickness of 350 μm was prepared as a base material. Next, the materials shown in Table 1 were blended to prepare a paint of Example 1 having the composition (parts by mass) shown in Table 1. The surface of the base material was coated with this paint using a bar coater and dried at 60° C. for one minute to form a coating film, which would later become a surface layer, on the surface of the base material. Methyl ethyl ketone was used as a solvent for the paint.

The coating film was then irradiated with excimer light (peak wavelength: 172 nm) in a nitrogen atmosphere by an excimer irradiation device (made by M.D. COM, Inc., product name: 172 nm air-cooled excimer irradiation device (model: MEIRA-MS-1-A4-H)) using Xe² as a discharge gas. The coating film was irradiated with a cumulative amount of light of 20 mJ/cm² at an irradiation intensity of 40 mW/cm².

By using an ultraviolet irradiation device (made by EYE GRAPHICS COMPANY, ultraviolet curing high pressure mercury lamp 4 KW (H04-L41)), the coating film was irradiated with ultraviolet rays (main wavelength: 365 nm) to photocure the coating film. A surface layer was thus formed on the surface of the base material. A decorative sheet was produced in this manner. The ultraviolet irradiation was performed at an ultraviolet irradiation distance of 15 cm and a lamp moving speed of 0.75 m/min, and the irradiation amount was 200 mJ/cm².

### <Thickness Measurement>

Next, the thickness T of the surface layer of the produced decorative sheet was measured using a digital microscope (made by KEYENCE CORPORATION, product name: VHX-5000) or a field emission scanning electron microscope (SEM) (made by Hitachi High-Tech Corporation, product name: S-4800).

More specifically, the sheet was cut to expose a section. The section was observed with the digital microscope (measurement magnification: 500×) or the field emission scanning electron microscope (measurement magnification: 1000×), and ten portions with a large coating film height and ten portions with a small coating film height were selected. The thicknesses of the selected portions were measured, and the average value of the measured thicknesses was calculated. This measurement was performed three times, and the average value of the coating film heights from the three measurements was calculated as the thickness T of the surface layer. The results are shown in Table 1.

### <Gloss Measurement>

Subsequently, the 60° gloss G of the surface layer of the produced decorative sheet was measured according to JIS Z 8741:1997 using a gloss meter (made by HORIBA, Ltd., product name: gloss checker IG-20). This measurement was performed five times, and the average value of the glosses from the five measurements was calculated as the gloss G of the surface layer.

The standard deviation σ_{G} was also calculated using the glosses from the five measurements. More specifically, the standard deviation σ_{G} was obtained by the following equation (1), where G₁, G₂, G₃, G₄, and G₅ represent the glosses from the five measurements. The results are shown in Table 1.

$$[ Math 1 ]$$

$${σ}_{G} = \sqrt{\frac{{\sum }_{i = 1}^{5} {( {G}_{i} - G )}^{2}}{4}} \qquad ( 1 )$$

### <Surface Roughness Measurement>

Subsequently, the surface roughness Sa of the surface layer of the produced decorative sheet (surface roughness of the opposite surface of the surface layer from the base material) was measured according to ISO 25178 by a shape analysis laser microscope (made by KEYENCE CORPORATION, product name: VK-X1000). The laser species used was a 404 nm semiconductor laser, and the measurement was performed over a 277 μm×208 μm area using a 50× standard objective lens. This measurement was performed ten times, and the average value of the surface roughnesses Sa from the ten measurements was calculated as the surface roughness Sa of the surface layer.

The standard deviation σ [μm] was also calculated using the surface roughnesses Sa from the ten measurements. More specifically, the standard deviation σ was obtained by the following equation (2), where Sa₁, Sa₂, Sa₃, Sa₄, Sa₅, Sa₆, Sa₇, Sa₈, Sa₉, and Sa₁₀ represent the surface roughnesses from the ten measurements. The results are shown in Table 1.

$$[ Math 2 ]$$

$$σ = \sqrt{\frac{{\sum }_{i = 1}^{10} {( S {a}_{i} - S a )}^{2}}{9}} \qquad ( 2 )$$

FIG. 2 is a laser micrograph showing the state of the surface of the surface layer in the decorative sheet of this example. It can be seen from FIG. 2 that the decorative sheet of this example has low glossiness and has an excellent aesthetic appearance with uniform asperities formed in the entire surface of the surface layer.

### Examples 2 to 8, Comparative Examples 1 to 7

Decorative sheets were produced in the same manner as in Example 1 described above except that the composition of the paint components was changed to the compositions (parts by mass) shown in Tables 1 and 2.

The thickness measurement, the gloss measurement, and the surface roughness measurement were performed in the same manner as in Example 1 described above. The results are shown in Tables 1 and 2.

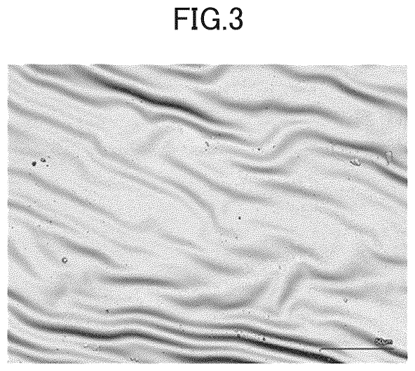

FIG. 3 is a laser micrograph showing the state of the surface of the surface layer in the decorative sheet of Comparative Example 3. It can be seen from FIG. 3 that the decorative sheet of Comparative Example 3 does not have a sufficient matting effect and has a less aesthetic appearance (design) with uneven asperities.

TABLE 1

| | | Number of | Example | Example | Example | Example | Example | Example | Example | Example |
|---|---|---|---|---|---|---|---|---|---|---|
| | | Functional Groups | 1 | 2 | 3 | 4 | 5 | 6 | 7 | 8 |
| Blending | Urethane Acrylate 1 | 9 | 100 | 100 | 100 | 100 | 100 | 100 | 100 | 100 |
| Ratio | Urethane Acrylate 2 | 10 | | | | | | | | |
| (Parts by | Urethane Acrylate 3 | 6 | | | | | | | | |
| Mass) | Mono-functional | 1 | 65 | 65 | 65 | 65 | 65 | 65 | 65 | 65 |
| | Acrylate | | | | | | | | | |
| | Initiator 1 | | 3.875 | 3.875 | 4 | 4 | 1.875 | 1.875 | 4 | 4 |
| | Initiator 2 | | | | | | 1.875 | 1.875 | | |
| | Solvent (Methyl Ethyl Ketone) | | 100 | 100 | 100 | 100 | 100 | 100 | 107.5 | 100 |
| | Silicone 1 | | 1.125 | 1.125 | 1.375 | 1.375 | 1.125 | | 1.125 | 0.375 |
| | Silicone 2 | | | | | | | | | |
| | Silicone 3 | | | | | | | 1.125 | | |
| Thickness T of Surface Layer [μm] | | | 3.5 | 7.1 | 3.5 | 7.1 | 3.5 | 3.5 | 7.1 | 7.1 |
| Evaluation | Gloss G [—] | Average Value | 2.3 | 1.9 | 2.3 | 2.3 | 2.2 | 2.3 | 1.7 | 3.2 |
| | | (n = 5) | | | | | | | | |
| | | Standard Deviation | 0.10 | 0.10 | 0.10 | 0.10 | 0.10 | 0.10 | 0.10 | 0.10 |
| | | (n = 5) | | | | | | | | |
| | Surface Roughness | Average Value [μm] | 1.0 | 1.4 | 1.2 | 1.1 | 1.2 | 1.1 | 1.3 | 1.1 |
| | Sa [μm] | (n = 10) | | | | | | | | |
| | | Standard Deviation | 0.02 | 0.08 | 0.05 | 0.07 | 0.05 | 0.05 | 0.04 | 0.09 |
| | | σ [μm] (n = 10) | | | | | | | | |

TABLE 2

| | | Number of | | | | | | | |
|---|---|---|---|---|---|---|---|---|---|
| | | Functional | Comparative | Comparative | Comparative | Comparative | Comparative | Comparative | Comparative |
| | | Groups | Example 1 | Example 2 | Example 3 | Example 4 | Example 5 | Example 6 | Example 7 |
| Blending | Urethane | 9 | 100 | 100 | | | 100 | 100 | 100 |
| Ratio | Acrylate 1 | | | | | | | | |
| (Parts by | Urethane | 10 | | | 100 | | | | |
| Mass) | Acrylate 2 | | | | | | | | |
| | Urethane | 6 | | | | 125 | | | |
| | Acrylate 3 | | | | | | | | |
| | Mono- | 1 | 65 | 65 | 100 | 67.5 | 65 | 65 | 65 |
| | functional | | | | | | | | |
| | Acrylate | | | | | | | | |
| | Initiator 1 | | 4 | 4 | 6.25 | | 1.875 | 4 | 4 |
| | Initiator 2 | | | | | | 1.875 | | |
| | Solvent (Methyl | | 102.5 | 102.5 | 208.75 | 118.75 | 96.25 | 100 | 100 |
| | Ethyl Ketone) | | | | | | | | |
| | Silicone 1 | | 4.125 | 4.125 | 2.125 | 2.75 | | | 0.013 |
| | Silicone 2 | | | | | | 4.375 | | |
| | Silicone 3 | | | | | | | | |
| Thickness T of Surface Layer [μm] | | | 3.5 | 7.1 | 3.5 | 3.5 | 3.5 | 3.5 | 3.5 |
| Evaluation | Gloss G | Average Value | 2.2 | 2 | 5.5 | 4.9 | 2.5 | 3.1 | 2.9 |
| | [—] | (n = 5) | | | | | | | |
| | | Standard Deviation | 0.10 | 0.10 | 0.1 | 0.4 | 0.10 | 0.10 | 0.10 |
| | | (n = 5) | | | | | | | |
| | Surface | Average Value [μm] | 1.4 | 1.6 | 1.1 | 1.0 | 1.3 | 1.3 | 1.2 |
| | Roughness | (n = 10) | | | | | | | |
| | Sa [μm] | Standard Deviation | 0.47 | 0.50 | 0.54 | 0.45 | 0.23 | 0.33 | 0.25 |
| | | σ [μm] (n = 10) | | | | | | | |

As shown in Table 1, in the decorative sheets of Examples 1 to 8, the gloss of the surface layer is equal to or less than 5. Therefore, these decorative sheets have low glossiness. Moreover, the standard deviation of the surface roughness Sa is 0.2 μm or less. These results show that the decorative sheets of Examples 1 to 8 have an excellent aesthetic appearance with uniform asperities formed in the entire surface of the surface layer.

As shown in Table 2, on the other hand, in the decorative sheets of Comparative Examples 1 to 7, the standard deviation of the surface roughness Sa is larger than 0.2 μm. This shows that the decorative sheets of Comparative Examples 1 to 7 have a less aesthetic appearance with uneven asperities formed in the entire surface of the surface layer.

Particularly in the decorative sheet of Comparative Example 3, the gloss of the surface layer is higher than 5. This shows that the surface layer has a high gloss (does not have low glossiness).

The above describes the embodiments of the present disclosure. However, the present disclosure is not limited only to the aforementioned embodiments, and various modifications are possible within the scope of the disclosure. That is, the above description of the embodiments is solely to serve as an example in nature, and is not intended to limit the present disclosure, applications thereof, or uses thereof.

1. A decorative sheet, characterized by comprising:
a base material; and
a surface layer located on the base material, wherein
the surface layer is composed of an ultraviolet-cured layer located on a surface of the base material and an excimer-cured layer located on a surface of the ultraviolet-cured layer,
the surface layer contains a urethane acrylate and silicone, and
a mass ratio of the urethane acrylate to the silicone in the surface layer is urethane acrylate:silicone=100:0.1 to 100:2.

2. The decorative sheet of claim 1, characterized in that
the silicone contains an acryloyl group.

3. The decorative sheet of claim 1, characterized in that
the surface layer has a gloss of 5 or less.

4. The decorative sheet of claim 1, characterized in that
a standard deviation of surface roughness of an opposite surface of the surface layer from the base material is 0.2 μm or less.
